(19) United States
(12) Patent Application Publication
(10) Pub. No.: US 2003/0157262 A1
(43) Pub. Date: Aug. 21, 2003

(54) Method for production and spray-application of a multicomponent paint

(76) Inventor: Dominique Cebola, Voiron (FR)

Correspondence Address: CANTOR COLBURN, LLP, 55 GRIFFIN ROAD SOUTH, BLOOMFIELD, CT, 06002

(21) Appl. No.: 10/297,904

(22) PCT Filed: Jun. 8, 2001
(86) PCT No.: PCT/FR01/01784

(30) Foreign Application Priority Data
Jun. 8, 2000 (FR) 00/07377

(51) Int. Cl. B05D 1/02

(52) U.S. Cl. 427/421; 239/68; 239/407

(57) ABSTRACT

The invention concerns a method for production and spray-application of a multicomponent paint in an installation comprising a main line (3) at one end of which emerges a conduit (4) supplying a base colour shade, and at the other end of which is mounted a sprayer (14), said line comprising a flow rate regulating device (10) controlling the flow of the product dispensed by the sprayer. Said method consists in: inputting at least a hardener in the main line from a secondary line; measuring in the main line the flow rate of the mixture comprising a base colour shade and hardeners; then, on the basis of the base colour shade/hardener volumetric ratio of the specific mixture, regulating the flow rate of each of the hardeners so as to obtain the predetermined volumetric ratio.

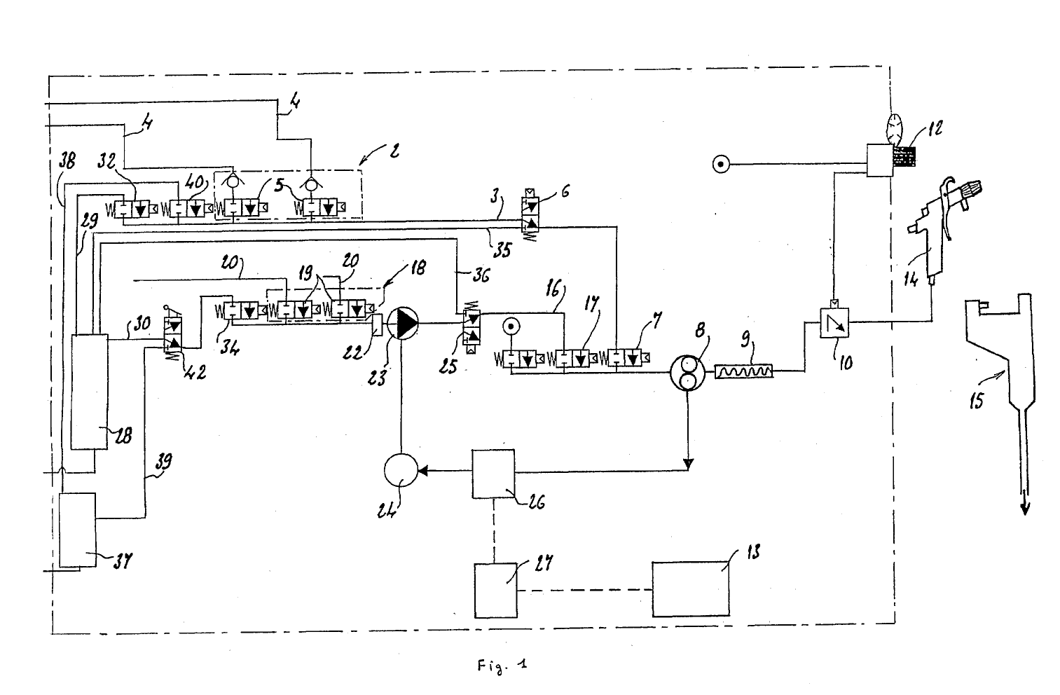

The subject of the present invention is a method of producing, and applying by spraying, a multicomponent paint and an installation for implementing this method.

A multicomponent paint consists of a base, generally colored, called hereafter the base color, which must be mixed in a precise ratio with at least one hardener before being sprayed by any paint spraying device.

One solution mentioned in document EP-0 210 282 consists in connecting up to the base circuit a metering pump driven by a motor which is itself supplied by a variable-frequency supply that makes it possible to vary its speed and consequently the product flow rate. It is also advisable to place, in each hardener supply circuit, a metering pump driven by a motor which is itself supplied by a variable-frequency supply, the installation including a system capable of operating the two variable-frequency supplies in order to obtain the correct flow rate and the correct mixing ratio. It is also known practice to place, in each of the circuits, downstream of the metering pump, a flow rate sensor making it possible to check whether each of the flow rates and the mixing ratio conform to the desired values. The mixed product passes through a static mixer so as to homogenize the mixture before it is sprayed.

In general, an installation is designed to produce and apply paints of different colors. It is possible, in such a case, to provide a color change unit upstream of the metering pump. It is then necessary to carry out a complete cleaning operation, upon changing colors, on the entire line between the color change unit and the sprayer. In order to lose the least possible amount of product during the color change phases, the motor-pump assembly is located as close as possible to the sprayer in an area classified as explosion-proof according to the regulations in force, thereby requiring the use of type-approved equipment. It is also possible to provide a motor-pump assembly for each color. The essential drawback with this type of system lies in the number of equipment items used and in the individual cost of each of them. This is because, as indicated above, it is recommended to increase the number of motor-pump assemblies and variable-frequency supplies that are associated with them.

If it is desired to limit the number of motor-pump assemblies, especially to use only one assembly per color, it is necessary on changing colors to carry out a complete cleaning operation, which is lengthy and relatively difficult to perform and requires a substantial consumption of a rinsing product, such as a solvent. Now, because of the increase in production rates, a color change must be carried out quickly and as economically as possible, while limiting the consumption of rinsing products.

It should be noted that these multicomponent paints are being increasingly used as they make it possible to meet environmental protection standards that require the amounts of solvent discharged, and also the energy needed for baking, to be reduced, since multicomponent paints contain substantially less solvent than conventional products.

However, installations for producing and applying multicomponent paints are distinguished from installations intended for producing and applying conventional solvent-based paints, these installations generally including a color change unit, a flow regulating device, such as a pressure regulator or a positive displacement pump allowing the flow rate to be controlled, and a flowmeter. Conventional installations of the latter type mentioned cannot therefore be reused immediately for producing multicomponent paints and applying them by spraying.

The object of the invention is to provide a method and an installation for producing multicomponent paints and applying them by spraying, which have a reasonable cost, which minimize the time to change colors and the amounts of rinsing product that are needed for cleaning the installation when changing colors, and which make it possible for an installation intended for producing a conventional monocomponent paint to be converted economically into an installation intended for producing and applying a multicomponent paint.

For this purpose, the method of producing, and of applying by spraying, a multicomponent paint in an installation comprising a main line into one end of which runs at least one line for supplying a base color and mounted on the other end of which is a sprayer, this line including a flow regulating device that determines the rate of flow of the product delivered by the sprayer, is characterized in that it consists in:

introducing, via a secondary line, at least one hardener into the main line;

measuring, in the main line, the flow rate of the mixture comprising a base color and hardeners;

and then, knowing the base color/hardener volume ratio of the mixture in question, regulating the flow rate of each of the hardeners so as to obtain the predetermined volume ratio.

An installation for carrying out this method, comprising a main line into one end of which runs, via a valve, at least one line for supplying a base color and mounted on the other end of which is a sprayer, this line including a flow regulating device that determines the rate of flow of the product delivered by the sprayer, is characterized in that at least one secondary line runs into this main line, at least one line for supplying a hardener running, via a valve, into the end of said secondary line, this line being equipped with a motor-pump assembly intended to transfer the hardener into the main line, the latter having, downstream of the point where it joins the secondary line and upstream of the pressure regulator, a flowmeter which, by continuously measuring the flow rate of the base color/hardener mixture, controls the motor-pump assembly by means of a variable-frequency supply so that the flow rate of the hardener sent by the pump into the main line makes it possible to respect a predetermined base color/hardener volume ratio.

The installation according to the invention is very similar to a conventional installation, since it simply includes the addition of at least one hardener line comprising a motor-pump assembly controlled by a variable-frequency supply, which hardener line joins the base line upstream of the flow meter. It should be noted that, unlike the installations that were described above and that constitute the prior art, it is unnecessary to provide in this case a metering pump in the main line and a metering pump in the secondary line, with regulation of these two pumps, since in the present case the pump placed in the secondary line is controlled on the basis of the total flow rate of the mixture which is imposed by the pressure regulator. According to one embodiment of this installation, the secondary line is equipped at its upstream end with a feed unit into which run, through the valves, several lines for supplying base colors. Furthermore, the secondary line is equipped at its upstream end with a feed unit into which run, through the valves, several lines for supplying hardener. According to one embodiment of this installation, the flowmeter mounted on the main line is a gear flowmeter. This gear flowmeter acts in the manner of an encoder on the means for controlling the motor of the pump.

In order to mix the base color with the hardeners, a static mixer is placed in the main line downstream of the flowmeter. This static mixer may, for example, be in the form of a longitudinal screw rotated by the flow of product, allowing intimate mixing of the components.

To allow the base color and the hardeners to pass into the main line or not, two triggering valves are placed in the main line and the secondary line, immediately upstream of their point of convergence.

Advantageously, the installation is supplemented with a rinsing product/air supply for cleaning and drying the various pipes and the components of the main line and of the secondary line. There are two types of cleaning or rinsing that can be employed:

rinsing during a change of colors or of hardener; and

rinsing when a lifetime limit of the mixed product is reached.

To allow rinsing during a color change, a supply of a rinsing product feeds lines that run through the valves into the upstream ends of the main line and the secondary line, respectively. It is thus possible to clean the main and secondary lines as far as the outlet of the cleaning product from the sprayer. After cleaning, it is recommended that any rinsing product remaining be removed. For this purpose, the installation includes a compressed-air supply feeding lines that run through the valves into the upstream ends of the main line and the secondary line, respectively.

To carry out an emergency rinsing operation when the lifetime limit of the mixed product is reached in the main line, the rinsing product supply also feeds two lines that run into two three-way valves mounted in the main line and in the secondary line upstream of the triggering valves and allow the passage of rinsing product alternating with the base color and the hardener, respectively. This makes it possible to rinse only lines containing mixed product. This is made possible by using the three-way valves, making it possible to choose between the product and the rinsing product, these valves being placed a few tens of centimeters from the corresponding triggering valves mounted in the main line and the secondary line, respectively.

Finally, this installation includes a controller for controlling the various functions of the installation and a control panel forming the interface with the operator and making it possible in particular to select the colors, to regulate the flow rate of product to be sprayed, to regulate, if it is not stored, a base color/hardener volume ratio, and to initiate a color change sequence whose various phases are managed by the controller.

In any case, the invention will be clearly understood with the aid of the following description, with reference to the single FIGURE of the appended schematic drawing showing, by way of nonlimiting example, a block diagram of the installation comprising, in order to make it easier to understand, only a single hardener line.

The installation shown in the drawing comprises a color change unit 2 from which a main line formed by a line 3 extends. A number of lines 4 run into the color change unit via valves 5. In the drawing, only two lines 4 have been shown, but of course the number of lines 4 that can supply different base colors may be greater. Placed in the line 3, downstream of the color change unit 2, is a three-way valve 6 and then a two-way triggering valve 7. Mounted downstream of the valve 7 is a gear flowmeter 8, then a static mixer 9, for example in the form of a longitudinal screw, and a pressure regulator 10 on the supply of which a pressure gauge 12 is mounted, the pressure being controlled by the operator by him acting on an indicator 13 or manually by means of a regulator pressure gauge. Finally, mounted in the main line 3 is a sprayer 14 which, when not being used, may be placed in a rinsing box 15 connected to a receptacle for recovering the product.

A secondary line 16 runs, immediately upstream of the flowmeter 8, via a triggering valve 17 into the main line 3. Mounted on the end of this line 16 is a hardener feed unit 18 into which run, via valves 19, lines 20 capable of supplying various types of hardener. Mounted downstream of the hardener feed unit 18 are a sensor 22 for detecting the presence of hardener, followed by a pump 23 actuated by a motor 24, this motor being equipped with a variable-frequency supply 26 allowing the speed of rotation of the pump to be varied. A three-way valve 25 is placed downstream of the pump 23 in the secondary line. As shown schematically in the drawing, the flowmeter is connected to the control unit of the motor 26 so as to vary, by means of the variable-frequency supply, the speed of rotation of the pump, in order to match said speed to the volume of color/hardener mixture to be produced. The indicator 13 is connected to a controller 27 which itself acts in particular on the control for the motor 26.

The installation also includes a supply 28 of a rinsing product, such as a solvent, said supply being connected via lines 29, 30 to the color change unit 2 and to the hardener feed unit 18, respectively. These two lines are equipped with valves 32 and 34 respectively. The rinsing product supply 28 is also connected via lines 35 and 36 to the main line 3 and to the secondary line 16, respectively, which rinsing product supply feeds into said lines at the three-way valves 6 and 25.

Finally, the installation includes a compressed-air feed supply 37 that feeds, via lines 38 and 39, the color change unit 32 and the hardener feed unit 18, respectively, the line 38 running into the color change unit 2 via a valve 40 and the line 39 running into the unit 18 via a three-way valve 42, where it meets the line 30 for feeding this same unit with solvent.

The operation of this installation is as follows. A base color feeding the color change unit 2 through an open valve 5 flows into the main line 3, through the valve 6 and the valve 7 as far as the flowmeter 8. In the secondary line 16, a hardener feeds the unit 18 through an open valve 19, this hardener being driven by the pump 23 after detection by the sensor 22. The three-way valve 25 allows passage of the hardener, as does the triggering valve 17, which is open. The hardener then joins the main line 3, to form with the base color a mixture whose flow rate is measured by the flowmeter 8. The operator having set the desired flow rate on the indicator 13 or the regulator pressure gauge 12, which controls the pressure regulator, the flowmeter sends to the motor-pump assembly 23, 24, via the control unit of the motor that acts on a variable-frequency supply, the speed of rotation of the pump in order to match the flow rate of hardener to the amount of the latter desired in the mixture. The flow rate of hardener delivered by the pump 23 results from a predetermined base color/hardener ratio. The product mixture passes through the static mixer and the pressure regulator 10 before being delivered by the sprayer 14. During operation, if the operator modifies the total product flow rate, the flowmeter will deliver the information to the control unit of the motor, which will consequently modify the speed of rotation of the pump 23. The sprayer may be a manual sprayer or an automatic sprayer mounted on the end of the arm of a robot.

Upon a color change, it is necessary to clean the lines 3 and 16. For this purpose, after closing the valves 5 and 19 previously supplying a color and a hardener to the units 2 and 18, the rinsing product is sent into the units via the lines 29 and 30, the valves 32 and 34 for feeding the units then being open. The rinsing product flows along the main line 3 and along the secondary line 16 as far as the spray gun 14, which is in the open position, the solvent being removed in the rinsing box 15. After the lines 3 and 16 have been cleaned by the rinsing product, they are dried with the aid of compressed air from the compressed-air supply 37, the air being supplied into the color change unit 2 and the hardener feed unit 18 through the lines 38, 39, the valves 40 and 34 being open, and the three-way valve 42 being switched in order to allow air to pass. By virtue of this arrangement, it is possible to rinse only the base circuit if the hardener does not have to be changed.

If there is a risk of the product formed by the base color/hardener mixture curing in the line 3, a so-called emergency rinsing operation has to be carried out, which requires only that part of the line containing the mixed product to be rinsed. For this purpose, the three-way valves 6 and 25 are switched into the position in which they no longer allow the base color and a hardener to pass, but the rinsing product.

The controller 27 controls the various operations of the installation and the indicator 13 or control panel forming the interface with the operator makes it possible in particular to select the colors, to adjust the flowrate of the sprayed product, to adjust, if it is not stored, a base color/hardener volume ratio and to initiate a color change sequence, the various phases of which, especially a cleaning phase, are managed automatically. The controller also is used to read the value of the total flowrate of the mixture flowing in the installation.

As is apparent from the foregoing, the invention affords a great improvement in the existing technique by providing a method and an installation for producing, and for applying by spraying, a two-component paint consisting of a base color and a hardener, making it possible to operate a conventional installation onto which a hardener supply line may be grafted.

In alternative embodiments (not shown), the main line could feed a second sprayer which is itself equipped with its pressure regulator, or the installation could include several secondary hardener lines.

1. A method of producing, and of applying by spraying, a multicomponent paint in an installation comprising a main line (3) into one end of which runs at least one line (4) for supplying a base color and mounted on the other end of which is a sprayer (14), this line including a flow regulating device (10) that determines the rate of flow of the product delivered by the sprayer, characterized in that it consists in:
introducing, via a secondary line, at least one hardener into the main line;
measuring, in the main line, the flow rate of the mixture comprising a base color and hardeners;
and then, knowing the base color/hardeners volume ratio of the mixture in question, regulating the flow rate of each of the hardeners so as to obtain the predetermined volume ratio.

2. An installation for producing, and for applying by spraying, a multicomponent paint consisting of a base color and at least one hardener, comprising a main line (3) into one end of which runs, via a valve (5), at least one line (4) for supplying a base color and mounted on the other end of which is a sprayer (14), this line (3) including a flow regulating device (10) that determines the rate of flow of the product delivered by the sprayer, characterized in that at least one secondary line (16) runs into this main line (3), at least one line (20) for supplying a hardener running, via a valve (19), into the end of said secondary line (16), this line (16) being equipped with a motor-pump assembly (23, 24) intended to transfer the hardener into the main line (3), the latter having, downstream of the point where it joins the secondary line and upstream of the pressure regulator (10), a flowmeter (8) which, by continuously measuring the flow rate of the base color/hardeners mixture, controls the motor-pump assembly by means of a variable-frequency supply so that the flow rate of the hardener sent by the pump (23) into the main line (3) makes it possible to respect a predetermined base color/hardeners volume ratio.

3. The installation as claimed in claim 2, characterized in that the main line (3) is equipped at its upstream end with a color change unit (2) into which run, through the valves (5) several lines (4) for supplying base colors.

4. The installation as claimed in either of claims 2 and 3, characterized in that the secondary line (16) is equipped at its upstream end with a feed unit (18) into which run, through the valves (19), several lines (20) for supplying hardener.

5. The installation as claimed in one of claims 2 to 4, characterized in that the flowmeter (8) mounted on the main line (3) is a gear flowmeter.

6. The installation as claimed in one of claims 2 to 5, characterized in that a static mixer (9) is placed in the main line downstream of the flowmeter (8).

7. The installation as claimed in one of claims 2 to 6, characterized in that two triggering valves (7, 17) are placed in the main line (3) and the secondary line (16), immediately upstream of their point of convergence.

8. The installation as claimed in one of claims 2 to 7, characterized in that it includes a supply (28) of a rinsing product, such as a solvent, feeding lines (29, 30) that run through the valves (32, 34) into the upstream ends of the main line (3) and the secondary line (16), respectively.

9. The installation as claimed in claims 7 and 8, characterized in that the rinsing product (28) supply (28) also feeds two lines (35, 36) that run into two three-way valves (6, 25) mounted in the main line (3) and in the secondary line (16) upstream of the triggering valves (7, 17) and allow the passage of solvent alternating with the base color and the hardener, respectively.

10. The installation as claimed in one of claims 2 to 9, characterized in that it includes a compressed-air supply (37) feeding lines (38, 39) that run through the valves (40, 34) into the upstream ends of the main line (3) and the secondary line (16), respectively.

11. The installation as claimed in all of claims 2 to 10, characterized in that it includes a controller (27) for controlling the various functions of the installation and a control panel (13) forming the interface with the operator and making it possible in particular to select the colors, to regulate the flow rate of the product to be sprayed, to regulate, if it is not stored, a base color/hardeners volume ratio, and to initiate a color change sequence whose various phases are managed by the controller.
